(19) United States
(12) Patent Application Publication
(10) Pub. No.: US 2006/0163532 A1
(43) Pub. Date: Jul. 27, 2006

(54) Compositions based on perfluoropolyether oils for forming lubricating films

(75) Inventors: Fiorenza D'Aprile, Milano (IT); Patrizia MacCone, Milano (IT)

Correspondence Address: ARENT FOX PLLC, 1050 CONNECTICUT AVENUE, N.W., SUITE 400, WASHINGTON, DC, 20036, US

(73) Assignee: SOLVAY SOLEXIS, S.p.A.

(21) Appl. No.: 11/324,805

(22) Filed: Jan. 4, 2006

(30) Foreign Application Priority Data
Jan. 5, 2005 (IT) MI2005 A 000006

(51) Int. Cl. C09K 3/00

(52) U.S. Cl. 252/182.11

(57) ABSTRACT

Compositions comprising: A) from 0.15% to 50% by weight of at least one perfluoropolyether oil; B) from 0.5% to 10% by weight of a (per)fluoropolyether compound having at least one end group selected from carboxylic, alcoholic, amidic, ketonic, amino, alkoxy functions; C) from 0.01% to 2% by weight of an organic or inorganic, solid or liquid non fluorinated additive; D) from 50% to 95% by weight of at least a fluorinated liquid having a boiling point in the range 20° C.-250° C., preferably 50° C.-190° C., selected from hydrofluoroethers, hydrofluoropolyethers, hydrofluorocarbons; the sum of the components A), B), C), D) being 100% by weight.

The present invention relates to stable perfluoropolyether-based compositions capable to form lubricating films.

More specifically the present invention relates to stable compositions, having a long shelf-life, capable to form thin and uniform lubricating films on surfaces, comprising at least a perfluoropolyether oil, at least a fluorinated liquid and liquid or solid non fluorinated additives.

Lubricating compositions comprising a fluorinated or non fluorinated lubricating oil and a solvent of the oil capable to form lubricating films on surfaces by depositing a thin lubricating layer after evaporation of the solvent, are known in the prior art. However the known compositions containing a fluorinated oil do not contain a solid hydrogenated additive to confer to the oils antirust, tracing, dyeing properties, etc.

See for example patent GB 2,358,189 describing compositions capable to form lubricating films on various surfaces comprising a fluorinated or non fluorinated lubricant dissolved in a fluorinated solvent selected from C₆F₁₃OCH₃ and C₆F₁₃H, used as carrier for said lubricant, optionally in admixture with other non fluorianted organic solvents. As said above, the compositions containing the fluorinated oil do not contain a solid hydrogenated additive to confer to said oils antirust, tracing, dyeing properties, etc.

U.S. Pat. No. 5,663,127 describes fluorinated compositions to lubricate magnetic media containing perfluoropolyether lubricants formed of perfluoropolyether having at least one hydrogen containing end group, and a non aromatic organic cyclic perfluorinated liquid solvent.

EP 760,809 describes compositions of hydrofluoroethers and highly fluorinated polyether oils for the lubrication of magnetic disks.

Lubricating compositions added of fluorinated or non fluorinated additives to improve the lubricating oil properties, for example the antiwear, antirust, antioxidant properties or to detect the presence or the lack of the lubricant, for example tracing agents, dyes, etc. are also known. However said additives must be soluble in said compositions to confer the above mentioned properties to the oil.

See for example U.S. Pat. No. 5,718,942 describing compositions capable to form a thin lubricating film on magnetic disks containing a perfluoropolyether oil in admixture with a partially fluorinated antioxidizing additive dissolved in fluoropentane.

See also U.S. Pat. No. 5,210,188, wherein compositions of perfluoropolyether oils containing dyeing substances are described. Also in this case said dyeing substances are based on perfluoropolyethers to obtain the dye solubilization in the oil. These compositions were used to detect the presence or the absence of the lubricating oil and the presence of the continuous film on the surface and thus to determine the lubrication quality. However the drawback of said dyes resides in that the process for preparing said fluorinated dyes is long and complicated and economically disadvantageous. See the process steps for this preparation. Besides also the reactants used for preparing the dyes are expensive. It is to be noted that in this case the compositions are coloured and therefore are not suitable for applications wherein it is required that the manufactured article remains unaltered after the treatment with the dye.

It is also known in the prior art that fluorescent tracing additives are particularly useful since they allow the control of the lubricating film homogeneity on substrata having a high roughness or unevenness without altering the surface appearance, in particular the colour, of the manufactured article.

See for example the patent application US 2003/0201423, wherein a lubricating composition is described formed of a non fluorinated solid lubricant (cetyl and stearyl alcohol), a non fluorinated diluent compatible with the solid lubricant, for example ethanol, and a non fluorinated fluorescent tracing additive.

Generally, as it is shown from the above patents, the additive must be soluble or finely dispersible in the components of the lubricating composition. For example, when a fluorinated lubricating oil is used, the additive must be soluble in this oil. See U.S. Pat. No. 5,210,188, wherein a specific dye was prepared in order to solubilize the compound in the oil.

It is to be noted that the use of non fluorinated additives in fluorinated lubricating compositions is highly desirable since it does not exist a wide range of fluorinated additives to cover all the requirements that the lubricating compositions must meet. Furthermore the non fluorinated additives are economically more advantageous.

The need was therefore felt to have available homogeneous and stable compositions, capable to form homogeneous lubricating films, based on fluorinated oils and solvents containing non fluorinated additives, without phase separations.

Compositions based on perfluoropolyether compounds have been surprisingly found capable to solve the above technical problem and to overcome the drawbacks of the prior art.

An object of the present invention are stable compositions comprising (in % by weight):
A) from 0.15% to 50%, preferably from 1% to 30%, of at least one perfluoropolyether oil;
B) from 0.5% to 10%, preferably from 1% to 5%, of a (per)fluoropolyether compound having at least one end group selected from carboxylic, alcoholic, amidic, ketonic, amino, alkoxy functions;
C) from 0.01% to 2%, preferably from 0.1% to 0.8% of an organic or inorganic, solid or liquid non fluorinated additive;
D) from 50% to 95% of at least one fluorinated liquid having a boiling point in the range 20° C.-250° C., preferably 50° C.-190° C., selected from hydrofluoroethers, hydrofluoropolyethers, hydrofluorocarbons;
   the sum of the components A), B), C), D) being 100% by weight.

Preferably component A) has a viscosity between 10 and 2,000 cSt, measuerd at 20° C. Besides component A) preferably comprises one or more units (CFXO) with X=F, CF₃; (CF₂CF₂O); (CF(CF₃)CF₂O); (CF₂CF₂CF₂O) statistically distributed along the backbone.

The perfluoropolyether oils of component A) are preferably selected from the following classes:
(1) E-O—(CF(CF₃)CF₂O)_{m′}(CFXO)_{n′}-E′

wherein:

X is equal to F or CF₃;

E and E′, equal to or different from each other, are selected from CF₃, C₂F₅ or C₃F₇, one fluorine atom of one or both end groups being replaceable with Cl and/or H;

m′ and n′ are integers such that the m′/n′ ratio is between 20 and 1,000, n′ being different from 0 and the viscosity of the product at 20° C. is between 10 and 4,000 cSt; the units being statistically distributed along the backbone.

These polymers can be obtained by perfluoropropene photooxidation as described in GB 1,104,432, and by subsequent conversion of the end groups as described in GB 1,226,566;
(2) C₃F₇O(CF(CF₃)CF₂O)_{o′}-D

wherein:

D is equal to —C₂F₅ or —C₃F₇, one fluorine atom of one or both end groups being replaceable with Cl and/or H;

o′ is an integer such that the viscosity of the product is within the range indicated under (1).

These polymers can be prepared by ionic oligomerization of the perfluoropropylenoxide and subsequent treatment with fluorine as described in U.S. Pat. No. 3,242,218;
(3) {C₃F₇O—(CF(CF₃)CF₂O)_{p′}-CF(CF₃)-}₂

wherein:

p′ is an integer such that the viscosity of the product is within the range indicated under (1), one F atom of one or both C₃F₇ end groups being replaceable with Cl and/or H.

These products can be obtained by ionic telomerization of the perfluoropropylenoxide and subsequent photochemical dimerization as reported in U.S. Pat. No. 3,214,478;
(4) E-O—(CF(CF₃)CF₂O)_{q′}(C₂F₄O)_{r′}(CFX)_{s′}-E′

wherein:

X is equal to F or CF₃;

E and E′, equal to or different from each other, are as above;

q′, r′ and s′ are integers including 0, and such that the viscosity of the product is within the range indicated under (1).

These polymers are obtainable by photooxidation of a C₃F₆ and C₂F₄ mixture and subsequent treatment with fluorine as described in U.S. Pat. No. 3,665,041;
(5) E-O—(C₂F₄O)_{t′}(CF₂O)_{u′}-E′

wherein:

E and E′, equal to or different from each other, are as above;

t′ and u′ are integers such that the t′/u′ ratio is between 0.1 and 5, u′ being different from 0 and the viscosity of the prodcut is within the above reported range under (1).

These polymers are obtained by photooxidation of C₂F₄ as reported in U.S. Pat. No. 3,715,378 and subsequent treatment with fluorine as described in U.S. Pat. No. 3,665,041;
(6) E-O—(CF₂CF₂CF₂O)_{v′}-E′

wherein:

E and E′, equal to or different from each other, are as above;

v′ is a number such that the viscosity of the product is within the above reported range under (1).

These polymers are obtained as described in EP 148,482;
(7) D-O—(CF₂CF₂O)_{z′}-D′

wherein:

D and D′, equal to or different from each other, are selected from C₂F₅ or C₃F₇, one fluorine atom of one or both end groups being replaceable with Cl and/or H;

z′ is an integer such that the viscosity of the product is within the above reported range under (1).

These polymers can be obtained as reported in U.S. Pat. No. 4,523,039.
(8) E₁-O(CF₂O)ₙ(CF₂CF₂O)ₘ-(CF₂CF₂CF₂O)ₚ(CF₂CF₂CF₂CF₂O)_{q}-E₂

wherein E₁ and E₂ are perfluoroalkyl end groups equal to or different from each other, having formula —(CF₂)_{z}CF₃

wherein z is an integer from 0 to 3; n, m, p, q are integers equal to or different from each other between 0 and 100 and selected so that the viscosity of the product is within the above indicated range under (1). These polymers are preparable according to EP 1,454,938 and according to the patent application EP 04 022 780.

As component A), mixtures of the perfluoropolyether oils of the above classes can be used.

Preferred perfluoropolyether oils are those of the classes (1), (4), (5), (8) or their mixtures and are available on the market as FOMBLIN® marketed by Solvay Solexis.

Preferably component B) has (CF₂O), (CF₂CF₂O), —CF(CF₃)—CF₂O—, —CF₂CF₂CF₂O— units statistically distributed along the backbone. Preferably compound B) has a number average molecular weight in the range 400-10,000, preferably 1,000-5,000.

Preferably the (per)fluoropolyether compound B) has the following general formula:
T-O—(CF₂O)ₘ-(CF₂CF₂O)ₙ(CF₂CF(CF₃)O)ₛ(CF(CF₃)O)ₚ-T′ (I)
wherein:

m, n, s, p, are integers such that the number average molecular weight of the structure (I) is in the range 400-10,000, preferably 1,000-5,000;

T and T′, equal to or different from each other, are selected from inert groups having the following formulas:

CF₂X—, C₂F₄X—, C₃F₆X—, with X=F, Cl; or from functional fluorinated groups containing carboxylic, alcoholic, amidic, ketonic, amino, alkoxy functions, with the proviso that at least one of T or T′ is a functional fluorinated group of those above described.

Examples of T, T′ are the following:

—CF₂COOH, —CF(CF₃)—COOH, —CF₂—CO—CF₃, —CF₂CONR₁R₂, CF(CF₃)CO—NR₁R₂, —CF₂C(CF₃)(OH)₂, —CF₂CH₂OH, —CF₂C(CF₃)(OH)(OH.HNR₁R₂), —CF(CF₃)—CH₂OH, —CF₂CH(CF₃)OH, —CF₂CY(CF₃)OH, —CF₂—COOZ; wherein R₁, R₂ can be equal or different and are selected from H, alkyls, alkylaryls, aryls, optionally substituted with —OH or halogens; Z=H, Na, K, NH₄, R′₁(R′₂)(R′₃)N wherein R′₁, R′₂ and R′₃ are indistinctly selected from H, alkyl or hydroxy-alkyl; Y=—OCH₃, —NH₂, —NR₁R₂.

Preferably compounds in B) are those satisfying the following conditions are satisfied: when none of the indexes (m, n, s, p) is zero, s/p ratio is between 8 and 12, s/n is between 0.5 and 1.5 and n/m ratio is between 8 and 12; when n=0, s/p ranges from 8 to 12, while s/m ranges from 18 to 22; when s=p=0, n/m ranges from 0.6 to 2.

The general structure (I) can also contain units of formula (—CF₂CF₂CF₂O—) and/or (—CF₂CF₂CF₂CF₂O—).

The preferred compounds B) are those having T=CF₃, T′=mixture of CF₂C(CF₃)(OH)₂ and CF₂COOH, n=0, or those with T=T′=CF₂COOH with s=p=0.

Mixtures of the above components B) can be used.

Components B) are known and are obtainable according to the process described in U.S. Pat. No. 5,124,058 or U.S. Pat. No. 3,810,874 to introduce the above functional end groups (in the PFPE backbones).

The non fluorinated additive C) is selected from the non fluorinated antiwear, antirust, antioxidant, dyeing and tracing additives, preferably from solid additives. More preferably component C) is selected from sebacates, in particular sodium sebacate (C₁₀H₁₆O₄Na₂), molybdenum organic salts, MOS₂, boron nitride, talc, graphite, benzotriazole, 2,5-bis(5-tert-butylbenzoxazol-2-yl)thiophene (commercially known as BBOT), metlylene blue, methyl red and mixtures thereof.

The hydrofluoroethers and hydrofluoropolyethers of the fluorinated solvent D) have general formula
R′—R_{f}—R (II)
wherein:
R′ is —(O)ₙ₀-CₙF₂ₙH, or —OR″, n being an integer from 1 to 4, preferably 1 or 2; n0 is an integer equal to 0, 1; and R″ an alkyl, preferably C₁-C₄;
R is —CₙF₂ₙH, —CₘF₂ₘ₊₁, or —R″ as above; wherein in the end groups R, R′ one fluorine atom is optionally substituted with one chlorine atom; n in R is as defined in R′; m is an integer from 1 to 3;
   R_{f} is

linear or branched perfluoroalkylene from 2 to 12 carbon atoms, containing at least one ether oxygen atom, when R_{f} has this meaning, n0 in R′ is preferably equal to zero;

perfluoropolyoxyalkylene comprising units statistically distributed along the chain, selected from the following:
(CFXO) wherein X=F or CF₃;
(CF₂ (CF₂)_{d}O) wherein d is an integer between 1 and 2;
(C₃F₆O), the unit (C₃F₆O) in R_{f} can have the following meanings: (CF₂CF(CF₃)O), (CF(CF₃)CF₂O);
   with the proviso that when R_{f} is perfluoropolyoxyalkylene n0 in R′ is preferably equal to 1.

Preferably in formula (II) R is a group selected from the following: —CF₂H, —CF₂CF₂H, —CFHCF₃.

The compounds of formula (II) generally have a number average molecular weight from 100 to 3,000, preferably from 200 to 800.

In compounds of formula (II) preferably R_{f}=(per)fluoropolyether chain and n0 is 1, R_{f} preferably has one of the following structures:
1) —(CF₂O)ₐ-(CF₂CF₂O)_{b}—

when a is different from zero, then b/a is between 0.3 and 10, extremes included; when a is equal to zero b is an integer as defined below;

R in formula (II)=—CₙF₂ₙH;
2) —(CF₂-(CF₂)_{z′}-CF₂O)_{b′}—

wherein z′ is an integer equal to 1 or 2; b′ is as defined below;
3) —(C₃F₆O)ᵣ-(C₂F₄O)_{b}-(CFL₀O)ₜ—

L₀=—F, —CF₃;

when b and t are different from zero, r/b=0.5-2.0; (r+b)/t=10-30 and all the units with r, b and t indexes are present;

or b=t=0 and r meets the condition indicated below;

or b=0 and r and t are different from zero;

a, b, b′, r, t, are integers such that or the sum of them is such that the compound of formula (II) containing the bivalent radical R_{f} has boiling point in the above range.

The fluorinated solvent D) can also be mixture(s) of compounds of formula (II). The fluorinated solvents D) of formula (II) are for example known from U.S. Pat. No. 3,704,214, U.S. Pat. No. 3,715,378, WO 95/32174 and U.S. Pat. No. 5,969,192.

The hydrofluorocarbons (HFC) of the solvent D) have general formula:
HₓF_{y}C_{z} (III)

wherein z is an integer between 4 and 8, and can be used in admixture with each other.

As component D), also mixtures of compounds of formula (II) and (III) can be used. Compounds of formula (II) are preferred.

The compositions of the invention can be prepared, for example, by mixing the compounds A), B) C) and D) under stirring, at room temperature. Preferably compound C) is added to compound B), the obtained mixture is added to A), and then to D).

Said compositions are ready-to-use and do not require dilutions. Furthermore they are stable (high shelf life) in a wide range of temperatures, for long periods, without clear separation of the components.

A further object of the present invention is the use of the above compositions for lubrication. In particular lubrication of metals, cast iron or their alloys, ceramic materials, polymeric materials, glass, wood, can be mentioned.

In particular, the compositions of the present invention are advantageously used to treat high roughness and evenness surfaces, thanks to their high wetting power. The compositions of the present invention allow to deposit on the manufactured article to be lubricated a thin homogeneous layer on the whole treated surface.

The results of the present invention are unexpected and surpris-ing since tests carried out by the Applicant have shown that compositions obtained by adding liquid or solid non fluorinated additives to lubricant compositions formed of perfluoropolyether oils and fluorinated solvents, for example those described in EP 760,809, are unstable and unhomogeneous, due to phase separation and therefore they are not usable for the desired use, for example for depositing tracing additive to detect the presence of the oil film (see the comparative Examples).

In particular, the Applicant has shown that the addition of a non fluorinated solid fluorescent additive, according to the patent application US 2003/0201423 teaching, to compositions containing a perfluoropolyether oil and a fluorinated solvent, brings to unstable lubricating compositions.

As said, the compositions of the present invention comprise non fluorinated solid additives without showing any substantial phase separation, thus resulting in homogeneous compositions, visually limpid and stable for at least 15 days, both at room temperature and at 5° C., preferably stable at least 2 months, more preferably at least 6 months (see the Examples).

The compositions of the present invention can be applied by known techniques to form films, for example by spraying, dip-coating and spreading, followed by solvent removal by evaporation at room temperature or at a temperature not higher than 100° C.

Some illustrative but not limitative Examples of the invention follow.

### EXAMPLES

### Characterization

Composition Stability

The compositions of the invention are placed in pirex glass test tubes with screw plug, thermostated at the test temperature by thermostatic bath or cryostat. 15 days elapsed, the test tube is extracted and it is visually observed: if the aspect is limpid and there is only one phase, the composition is evaluated stable and the test result is POSITIVE. If on the contrary the test tube aspect is not limpid or more phases are present, then the composition is evaluated unstable and the test result is NEGATIVE.

### Example 1

A composition of the present invention is prepared as follows under stirring: 0.002 g of a product C) having the following structure: 2,5-bis(5-tert-butyl-benzoxazol-2-yl)-thiophene (BBOT) as tracing additive detectable by UV, are added to 1 g of product B) of general formula (I) wherein T=—CF₃, and T′=—CF₂C(CF₃)(OH)₂ (75% by moles) and —CF₂COOH (25% by moles) and with n=0, s/p=10, s/m=20, p/m=2; then the mixture C)+B) is added to 20 g of oil A) of class (1), commecially known as Fomblin® YPL 1500, having kinematic viscosity at 20° C. of 1500 cSt (MW=5500-7300) and to 78.008 g of a fluorinated solvent D) of formula:
HCF₂-O—(CF₂CF₂O)₃-(CF₂O)_{0,4}-CF₂H
and boiling point of 130° C., commercially known as H-Galden® ZT130.

The so obtained composition is subjected to the stability evaluation at room temperature and at 5° C. The test result is POSITIVE in both set temperature conditions.

Furthermore said composition resulted stable even after two months from its preparation.

### Example 2

The Example 1 was repeated by using as fluorinated solvent D) an hydrofluoropolyether of formula
HCF₂-O—(CF₂CF₂O)_{0,9}-(CF₂O)_{0,1}-CF₂H
and boiling point of 60° C., commercially known as H-Galden® ZV60.

The so obtained composition is subjected to the stability evaluation at room temperature and at 5° C.

The test result is POSITIVE in both set temperature conditions.

Furthermore said compoistion resulted stable even after two months from its preparation.

### Example 3

The Example 1 was repeated by using as fluorinated solvent D) an hydrofluoroether of formula:
C₄F₉OCH₃
and boiling point of 61° C., commercially known as HFE® 7100.

The so obtained composition is subjected to the stability evaluation at room temperature and at 5° C.

The test result is POSITIVE in both set temperature conditions.

Furthermore said compoistion resulted stable even after two months from its preparation.

### Example 4

The Example 1 was repeated by using as fluorinated solvent D) an hydrofluorocarbon of formula:
CF₂-CFH—CFH—CF₂-CF₃
and boiling point of 55° C., commercially known as Vertrel® XF.

The so obtained composition is subjected to the stability evaluation at room temperature and at 5° C.

The test result is POSITIVE in both set temperature conditions.

Furthermore said compoistion resulted stable even after two months from its preparation.

### Example 5

The Example 1 was repeated by using as perfluoropolyether oil A) a perfluoropolyether of the class (5), having kinematic viscosity at 20° C. of 300 cSt, commercially known as Fomblin® M 30.

The so obtained composition is subjected to the stability evaluation at room temperature and at 5° C.

The test result is POSITIVE in both set temperature conditions.

Furthermore said compoistion resulted stable even after one month from its preparation.

### Example 6

The Example 2 was repeated by using as (per)fluoropolyether compound B) a compound of formula (I) wherein T=T′=—CF₂COOH, with s=p=0, and n/m from 0.6 to 2, commercially known as Fluorolink® C 10.

The so obtained composition is subjected to the stability evaluation at room temperature and at 5° C.

The test result is POSITIVE in both set temperature conditions.

Furthermore said composition resulted stable even after two months from its preparation.

### Example 7

A composition of the present invention is prepared as follows under stirring: 1 g of a product C) of formula C₁₀H₁₆O₄Na₂, known as sodium sebacate, as antioxidation additive, is added to 3 g of component B) of the Example 1 of general formula (I) wherein T=—CF₃, and T′=—CF₂C(CF₃)(OH)₂ (75% by moles) and —CF₂COOH (25% by moles) and with n=0, s/p=10, s/m=20, p/m=2; then the mixture C)+B) is added to 46 g of component A) of the class (1), used in the Example 1, commecially known as Fomblin® YPL 1500, having kinematic viscosity at 20° C. of 1500 cSt (MW=5500-7300) and to 50 g of component D) used in the Example 1, having the following structure:
HCF₂-O—(CF₂CF₂O)₃-(CF₂O)_{0,4}-CF₂H
and boiling point of 130° C., commercially known as H-Galden® ZT130.

The so obtained composition is subjected to the stability evaluation at room temperature and at 5° C.

The test result is POSITIVE in both set temperature conditions.

### Example 8 (Comparative)

The Example 1 was repeated but by using as solvent D), a perfluorinated solvent (Galden SV 70 having a boiling point of 70° C.).

The so obtained composition is subjected to the stability evaluation at room temperature and at 5° C.

The test result is NEGATIVE in both set temperature conditions, in particular phase separation is observed, a time lower than 2 hours elapsed.

### Example 9 (Comparative)

The Example 7 was repeated but by using as solvent D), a perfluorinated solvent (Galden SV 70 having a boiling point of 70° C.).

The so obtained composition is subjected to the stability evaluation at room temperature and at 5° C.

The test result is NEGATIVE in both set temperature conditions, in particular phase separation is observed, a time lower than 2 hours elapsed.

### Example 10 (Comparative)

The Example 6 was repeated but not using the invention (per)fluoropolyether compound B).

The so obtained composition is subjected to the stability evaluation at room temperature and at 5° C.

The test result is NEGATIVE in both set temperature conditions, in particular phase separation is observed, a time lower than 2 hours elapsed.

### Example 11 (Comparative)

The Example 7 was repeated but in absence of the invention (per)fluoropolyether compound B).

The so obtained composition is subjected to the stability evaluation at room temperature and at 5° C.

The test result is NEGATIVE in both set temperature conditions, in particular phase separation is observed, a time lower than 2 hours elapsed.

### Example 12 (Comparative)

0.1 g of sodium sebacate, C₁₀H₁₆O₄Na₂ (component C)), are mixed under stirring with 100 g of a fluorinated solvent D) of formula:
HCF₂-O—(CF₂CF₂O)₃-(CF₂O)_{0,4}-CF₂H
commercially known as H-Galden® ZT130.

Two non miscible phases are observed, even after prolonged stirring, whereby the two components do not chemically result similar. Therefore the fluorinated compound D) is not a solvent of compound C).

### Example 13 (Comparative)

The Example 12 is repeated but by using, as fluorinated solvent D), a hydrofluoropolyether having the following structure:
HCF₂-C—(CF₂CF₂O)_{0,9}-(CF₂O)_{0,1}-CF₂H
commercially known as H-Galden® ZV60.

Two non miscible phases are observed, even after prolonged stirring, whereby the two components do not chemically result similar. Therefore the fluorinated compound D) is not a solvent of compound C).

### Example 14 (Comparative)

0.1 g of sodium sebacate, C₁₀H₁₆O₄Na₂ (component C)), are added under stirring with 100 g of product B) of the Example 6, of general formula (I) wherein T=T′=—CF₂COOH, with s=p=0, and n/m from 0.6 to 2, commercially known as Fluorolink® C 10.

Two non miscible phases are observed, even after prolonged stirring, whereby the two components do not chemically result similar. Therefore the (per)fluoropolyether compound B) is not a solvent of compound C).

### APPLICATION EXAMPLES

### Example 15

The composition of the Example 1 was prepared and left in a closed vessel at room temperature for 24 hours. Then a rectangle-shaped copper plate having 15×6 mm size is completely dipped for 1 minute into the previously prepared composition. Said period of time elapsed, the plate is removed from the composition and dried at the air for 15 minutes. Then the plate is put under UV lamp (370 nm) for the homogeneity evaluation of the deposited lubricating film. It is visually observed the presence of fluorescence uniformly distributed on the whole piece.

### Example 16 (Comparative)

The Example 15 was repeated but by using the composition of the Example 8. The treated copper plate does not show any fluorescence when put under the UV lamp.

This shows that on the plate no fluorescent additive settled.

From the comparison of the Example 15 with the Example 16 it results that the homogeneous composition of the present invention allows to deposit in a substantially homogeneous way the tracing (fluorescent) additive on the treated surface and therefore to detect the lubricating film.

This results very useful and advantageous for the quality control of parts produced in series.

As a matter of fact, in lubricants not containing fluorescent additives one is not capable to determine the presence of the lubricating film. This represents a drawback since many pieces not containing the lubricating film are refused by the final user and returned.

TABLE 1

| | COMPOSITION | | | | Stability |
|---|---|---|---|---|---|
| Example | Component A) | Component B) | Component C) | Component D) | test |
| 1 | Fomblin ® YPL 1500 | (per)fluoropolyether (I) | BBOT | H-Galden ® ZT130 | POSITIVE |
| 2 | Fomblin ® YPL 1500 | (per)fluoropolyether (I) | BBOT | H-Galden ® ZV60 | POSITIVE |
| 3 | Fomblin ® YPL 1500 | (per)fluoropolyether (I) | BBOT | HFE ® 7100 | POSITIVE |
| 4 | Fomblin ® YPL 1500 | (per)fluoropolyether (I) | BBOT | Vertrel ® XF | POSITIVE |
| 5 | Fomblin ® M 30 | (per)fluoropolyether (I) | BBOT | H-Galden ® ZT130 | POSITIVE |
| 6 | Fomblin ® YPL 1500 | Fluorolink ® C 10 | BBOT | H-Galden ® ZV60 | POSITIVE |
| | | (Formula (I)) | | | |
| 7 | Fomblin ® YPL 1500 | (per)fluoropolyether (I) | Sodium sebacate | H-Galden ® ZT130 | POSITIVE |
| 8 (comp) | Fomblin ® YPL 1500 | (per)fluoropolyether (I) | BBOT | perfluorinated solvent | NEGATIVE |
| | | | | (Galden SV 70) | |
| 9 (comp) | Fomblin ® YPL 1500 | (per)fluoropolyether (I) | Sodium sebacate | perfluorinated solvent | NEGATIVE |
| | | | | (Galden SV 70) | |
| 10 (comp) | Fomblin ® YPL 1500 | — | BBOT | H-Galden ® ZV60 | NEGATIVE |
| 11 (comp) | Fomblin ® YPL 1500 | — | Sodium sebacate | H-Galden ® ZT130 | NEGATIVE |
| 12 (comp) | — | — | Sodium sebacate | H-Galden ® ZT130 | NEGATIVE |
| 13 (comp) | — | — | Sodium sebacate | H-Galden ® ZV60 | NEGATIVE |
| 14 (comp) | — | Fluorolink ® C 10 | Sodium sebacate | — | NEGATIVE |
| | | (Formula (I)) | | | |

1. Compositions comprising (in % by weight):
A) from 0.15% to 50%, preferably from 1% to 30%, of at least one perfluoropolyether oil;
B) from 0.5% to 10%, preferably from 1% to 5%, of a (per)fluoropolyether compound having at least one end group selected from carboxylic, alcoholic, amidic, ketonic, amino, alkoxy functions;
C) from 0.01% to 2%, preferably from 0.1% to 0.8% of a solid or liquid, organic or inorganic, non fluorinated additive;
D) from 50% to 95% of at least one fluorinated liquid having a boiling point in the range 20° C.-250° C., preferably 50° C.-190° C., selected from hydrofluoroethers, hydrofluoropolyethers, hydrofluorocarbons;
the sum of the components A), B), C), D) being 100% by weight.

2. Compositions according to claim 1, wherein component A) preferably has a viscosity between 10 and 2,000 cSt, measuerd at 20° C.

3. Compositions according to claims 1-2, wherein component A) comprises one or more units (CFXO) with X=F, CF₃; (CF₂CF₂O); (CF(CF₃)CF₂O); (CF₂CF₂CF₂O) statistically distributed along the backbone.

4. Compositions according to claims 1-3, wherein the perfluoropolyether oils of component A) are selected from the following classes:
(1) E-O—(CF(CF₃)CF₂O)_{m′}(CFXO)_{n′}-E′
wherein:
X is equal to F or CF₃;
E and E′, equal to or different from each other, are selected from CF₃, C₂F₅ or C₃F₇, one fluorine atom of one or both end groups being replaceable with Cl and/or H;
m′ and n′ are integers such that the m′/n′ ratio is between 20 and 1,000, n′ being different from 0 and the viscosity of the product at 20° C. is between 10 and 4,000 cSt; the units being statistically distributed along the backbone;
(2) C₃F₇O(CF (CF₃)CF₂O)_{o′}-D
wherein:
D is equal to —C₂F₅ or —C₃F₇, one fluorine atom of one or both end groups being replaceable with Cl and/or H;
o′ is an integer such that the viscosity of the product is within the range indicated under (1);
(3) {C₃F₇O—(CF(CF₃)CF₂O)_{p′}-CF(CF₃)-}₂
wherein:
p′ is an integer such that the viscosity of the product is within the range indicated under (1), one F atom of one or both C₃F₇ end groups being replaceable with Cl and/or H.
(4) E-O—(CF(CF₃)CF₂O)_{q′}(C₂F₄O)_{r′}(CFX)_{s′}-E′
wherein:
X is equal to F or CF₃;
E and E′, equal to or different from each other, are as above;
q′, r′ and s′ are integers including 0, and such that the viscosity of the product is within the range indicated under (1);
(5) E-O—(C₂F₄O)_{t′}(CF₂O)_{u′}-E′
wherein:
E and E′, equal to or different from each other, are as above;
t′ and u′ are integers such that the t′/u′ ratio is between 0.1 and 5, u′ being different from 0 and the viscosity of the product is within the above reported range under (1).
(6) E-O—(CF₂CF₂CF₂O)_{v′}-E′
wherein:
E and E′, equal to or different from each other, are as above;
v′ is a number such that the viscosity of the product is within the above reported range under (1).
(7) D-O—(CF₂CF₂O)_{z′}-D′
wherein:
D and D′, equal to or different from each other, are selected from C₂F₅ or C₃F₇, one fluorine atom of one or both end groups being replaceable with Cl and/or H;
z′ is a number such that the viscosity of the product is within the above reported range under (1).
(8) E₁-O(CF₂O)ₙ(CF₂CF₂O)ₘ-(CF₂CF₂CF₂O)ₚ(CF₂CF₂CF₂CF₂O)_{q}-E₂
wherein E₁ and E₂ are perfluoroalkyl end groups equal to or different from each other, having formula —(CF₂)_{z}CF₃ wherein z is an integer from 0 to 3; n, m, p, q are integers equal to or different from each other between 0 and 100 and selected so that the viscosity of the product is within the above indicated range under (1).

5. Compositions according to claims 1-4, wherein, as component A), mixtures of perfluoropolyether oils of the above classes can be used.

6. Compositions according to claims 4-5, wherein the perfluoropolyether oils of component A) are those of the classes (1), (4), (5), (8) or their mixtures.

7. Compositions according to claims 1-6, wherein component B) contains (CF₂O), (CF₂CF₂O), —CF(CF₃)CF₂O—, —CF₂CF₂CF₂O— units statistically distributed along the backbone.

8. Compositions according to claims 1-7, wherein component B) has a number average molecular weight in the range 400-10,000, preferably 1,000-5,000.

9. Compositions according to claims 1-8, wherein the (per)fluoropolyether compound B) has the following formula:
T-O—(CF₂O)ₘ-(CF₂CF₂O)ₙ(CF₂CF(CF₃)O)ₛ(CF(CF₃)O)ₚ-T′ (I)
wherein:
m, n, s, p, are integers such that the number average molecular weight of the structure (I) is in the range 400-10,000, preferably 1,000-5,000;
T and T′, equal to or different from each other, are selected from inert groups having the following formulas: CF₂X—, C₂F₄X—, C₃F₆X—, with X=F, Cl; or from functional fluorinated groups containing carboxylic, alcoholic, amidic, ketonic, amino, alkoxy functions, with the proviso that at least one of T or T′ is a functional fluorinated group of those above described.

10. Compositions according to claim 9, wherein the end groups T, T′ of the (per) fluoropolyether compound B) are selected from —CF₂COOH, —CF(CF₃)—COOH, —CF₂—CO—CF₃, —CF₂CONR₁R₂, —CF(CF₃)CONR₁R₂, —CF₂C(CF₃)(OH)₂, —CF₂CH₂OH, CF₂C(CF₃)(OH)(OH.HNR₁R₂), —CF(CF₃)—CH₂OH, —CF₂CH (CF₃)OH, —CF₂CY(CF₃)OH, —CF₂—COOZ; wherein R₁, R₂ can be equal or different and are selected from H, alkyls, alkylaryls, aryls, optionally substituted with —OH or halogens; Z=H, Na, K, NH₄, R′₁(R′₂) (R′₃)N wherein R′₁, R′₂, and R′₃ are indistinctly selected among H, alkyl or hydroxyalkyl; Y═—OCH₃, —NH₂, —NR₁R₂.

11. Compositions according to claims 9-10, wherein the (per)fluoropolyether compounds B) of formula (I) satisfy the following conditions: when none of the indexes (m, n, s, p) is zero, s/p ratio is between 8 and 12, s/n is between 0.5 and 1.5 and n/m ratio is between 8 and 12; when n 0, s/p ranges from 8 to 12, while s/m ranges from 18 to 22; when s=p=0, n/m ranges from 0.6 to 2.

12. Compositions according to claims 9-11, wherein compounds B) have T=CF₃, T′=mixture of CF₂C(CF₃)(OH)₂ and CF₂COOH, n=0 or have T=T′=CF₂COOH with s=p=0.

13. Compositions according to claims 1-12, wherein the non fluorinated additive C) is selected from the non fluorinated antiwear, antirust, antioxidant, dyeing and tracing additives, preferably from solid additives.

14. Compositions according to claims 1-13, wherein the additive C) is selected from sebacates, preferably sodium sebacate (C₁₀H₁₆O₄Na₂), molybdenum organic salts, MOS₂, boron nitride, talc, graphite, benzotriazole, 2,5-bis(5-tert-butylbenzoxazol-2-yl)thiophene (commercially known as BBOT), methylene blue, methyl red and their mixtures.

15. Compositions according to claims 1-14, wherein the hydrofluoroethers and the hydrofluoropolyethers of the fluorinated solvent D) have general formula
R′—R_{f}—R (II)
wherein:
R′ is —(O)ₙ₀-CₙF₂ₙH, or —OR″, n being an integer from 1 to 4, preferably 1 or 2; n0 is an integer equal to 0, 1; and R″ an alkyl, preferably C₁-C₄;
R is —CₙF₂ₙH, —CₘF₂ₘ₊₁, or —R″ as above; wherein in the end groups R, R′ one fluorine atom is optionally substituted with one chlorine atom; n in R is as defined in R′; m is an integer from 1 to 3;
R_{f} is
linear or branched perfluoroalkylene from 2 to 12 carbon atoms, containing at least one ether oxygen atom, when R_{f} has this meaning n0 in R′ is preferably equal to zero;
perfluoropolyoxyalkylene comprising units statistically distributed along the chain, selected from the following:
(CFXO) wherein X=F or CF₃;
(CF₂(CF₂)_{d}O) wherein d is an integer between 1 and 2;
(C₃F₆O), the unit (C₃F₆O) in R_{f} can have the following meanings: (CF₂CF(CF₃)O), (CF(CF₃—)CF₂O );
with the proviso that when R_{f} is perfluoropolyoxyalkylene n0 in R′ is preferably equal to 1.

16. Compositions according to claim 15, wherein in formula (II) R is a group selected from the following: —CF₂H, —CF₂CF₂H, —CFHCF₃.

17. Compositions according to claims 15-16, wherein the compounds of formula (II) have a number average molecular weight from 100 to 3,000, preferably from 200 to 800.

18. Compositions according to claims 15-17, wherein in the compounds of formula (II) R_{f}=(per)fluoropolyether chain with n0 of R′ equal to 1.

19. Compositions according to claim 18, wherein R_{f} in formula (II) has one of the following structures:
1) —(CF₂O)ₐ-(CF₂CF₂O)_{b}—
when a is different from zero, then b/a is between 0.3 and 10, extremes included; when a is equal to zero b is an integer as defined below;
R in formula (II)=—CₙF₂ₙH;
2) —(CF₂-(CF₂)_{z′}-CF₂O)_{b′}—
wherein z′ is an integer equal to 1 or 2; b′ is as defined below;
3) —(C₃F₆O)ᵣ-(C₂F₄O)_{b}-(CFL₀O)ₜ—
L₀=—F, —CF₃;
when b and t are different from zero r/b=0.5-2.0; (r+b)/t=10-30 and all the units with r, b and t indexes are present;
or b=t=0 and r meets the condition indicated below;
or b=0 and r and t are different from zero;
a, b, b′, r, t, are integers such that or the sum of them is such that the compound of formula (II) containing the bivalent radical R_{f} has boiling point in the above range.

20. Compositions according to claims 15-19, wherein the fluorinated solvent D) can be a mixture of compounds of formula (II).

21. Compositions according to claims 1-14, wherein the hydrofluorocarbons of the solvent D) have general formula:
HₓF_{y}C_{z} (III)
wherein z is an integer between 4 and 8, and can be used in admixture with each other.

22. Compositions according to claims 1-21, wherein component D) is a mixture of compounds of formula (II) and (III).

23. Compositions according to claims 1-22, wherein as component D) compounds of formula (II) are used.

24. Use of the compositions according to claims 1-23 for lubrication.

25. Use according to claim 24 for the lubrication of metals, steels, cast iron or their alloys, ceramic materials, polymeric materials, glass, wood.

26. Use according to claims 24-25 to treat surfaces having a high roughness and evenness.
